(19) United States
(12) Patent Application Publication
(10) Pub. No.: US 2012/0116895 A1
(43) Pub. Date: May 10, 2012

(54) Customizable Marketing Campaign Framework

(75) Inventors: Carlos S. Catalahana, Huntersville, NC (US); Leslie Jaye Lochman, Charlotte, NC (US)

(73) Assignee: Bank of America Corporation, Charlotte, NC (US)

(21) Appl. No.: 13/021,839

(22) Filed: Feb. 7, 2011

Related U.S. Application Data
(60) Provisional application No. 61/410,010, filed on Nov. 4, 2010.

(51) Int. Cl. G06Q 30/00

(52) U.S. Cl. 705/14.72

(57) ABSTRACT

A system and method of creating and generating marketing campaigns is provided. The system and method may include generating a plurality of customizable marketing campaign components. One or more marketing campaign components may be selected, such as by a user, for insertion into the marketing campaign and, in some examples, the marketing campaign components may be predefined or preconfigured and/or may be customizable by a user. Upon selection of the desired marketing campaign component(s), the marketing campaign system may generate the marketing campaign based on the selected components for use, for instance, as a web-based advertisement or marketing promotion.

### CROSS REFERENCE TO RELATED APPLICATIONS

This application is a non-provisional application of and claims the benefit of priority from U.S. Provisional Application Ser. No. 61/410,010, entitled “Customizable Marketing Campaign Framework,” filed Nov. 4, 2010, which is incorporated herein by reference in its entirety.

Aspects of this disclosure are related to U.S. provisional application Ser. No. 61/236,135, filed Aug. 23, 2009 and entitled “Enhanced Electronic Platform and Related Components,” the contents of which are herein incorporated by reference in their entirety.

Apsects of this disclosure are related to U.S. non-provisional application Ser. No. 12/771,807, entitled “Dynamic Configuration System,” filed Apr. 30, 2010, the contents of which are herein incorporated by reference in their entirety

### BACKGROUND

In today's corporate world, improvements in efficiency, reduction in costs and, in some industries, compliance with industry standards, government regulations, etc. are factors to success. Accordingly, companies are constantly striving to achieve these factors. For instance, in today's Internet based environment, marketing and advertising campaigns are often changing more rapidly than in the past. Accordingly, the cost associated with these campaigns is increasing due to the increasing number of campaigns, desire for different campaigns for different business units within a company, etc. Use of outside marketing firms can be costly, time consuming, and may result in products that do not meet company standards, government regulations, and the like. Accordingly, a system and method for customizing and building advertising, marketing, etc. campaigns, applications, etc. within a company would be advantageous.

### SUMMARY

The following presents a simplified summary in order to provide a basic understanding of some aspects of the present disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

According to one or more aspects, a system and method of creating and/or generating a marketing campaign are provided. In at least some examples, the system and method may include generating a plurality of predefined and/or preconfigured marketing campaign components. The marketing campaign components may be provided to a user for selection. Upon selection of a marketing campaign component, the user may customize the selected marketing campaign component, such as by inserting text, modifying a font style, font color, adding graphics, and/or the like. The user may be prompted to select additional marketing campaign components as desired.

Upon selection/customization of all desired marketing campaign components, a marketing campaign may be generated based on the selected/customized marketing campaign components. The marketing campaign may be used, for instance, as a web-based advertisement for goods, services, etc. as desired.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example system for creating and/or generating a marketing campaign according to one or more aspects described herein.

FIG. 3 illustrates one example method of creating and/or generating a marketing campaign using a marketing campaign system according to one or more aspects described herein.

FIG. 4 illustrates another example method of creating and/or generating a marketing campaign using a marketing campaign system according to one or more aspects described herein.

FIG. 5 illustrates one example user interface for accessing the marketing campaign system according to one or more aspects described herein.

FIG. 6 illustrates one example user interface for selecting marketing campaign components according to one or more aspects described herein.

FIG. 7 illustrates one example user interface for customizing a selected marketing campaign component according to one or more aspects described herein.

FIG. 8 illustrates one arrangement of a system in accordance with aspects of the disclosure.

FIG. 9 is a flowchart illustrating one arrangement of a method in accordance with aspects of the disclosure.

FIG. 10 illustrates an exemplary properties file in accordance with aspects of the disclosure.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

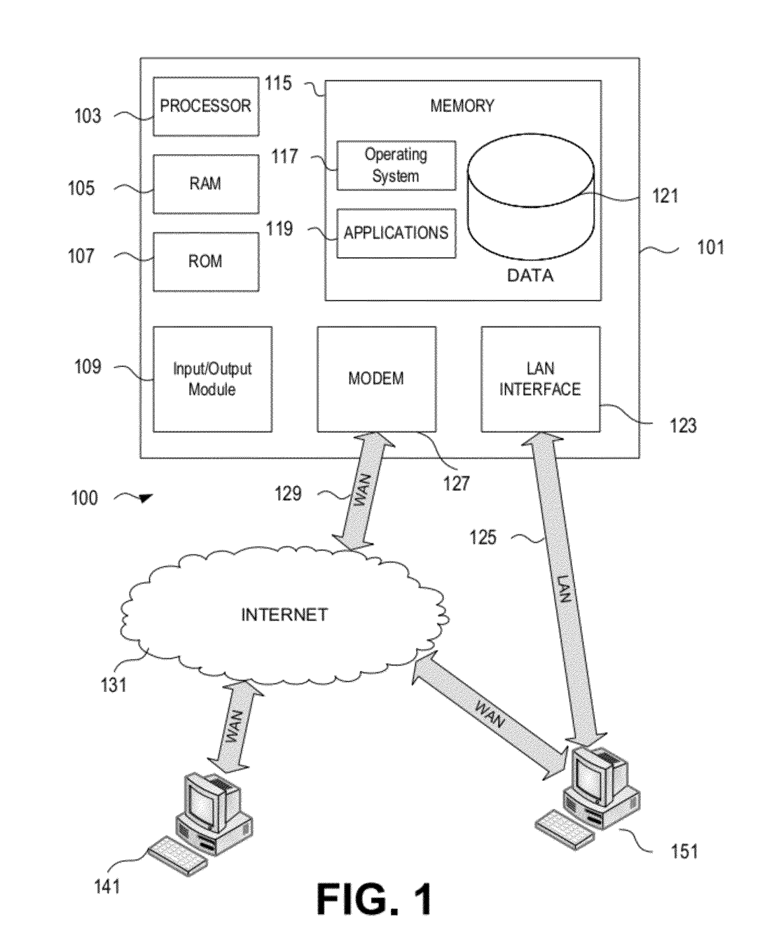

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in various businesses, companies, organizations, entities, etc. to provide a modular, customizable marketing campaign system or framework for creating a marketing campaign, advertising promotion, etc. In some arrangements, the marketing campaign may be provided to customers, potential customers etc., via the Internet. For example, marketing campaigns created using this system may appear on a website of the company implementing the system, or other website, to market or promote new products, services, and the like.

In some examples, a plurality of customizable marketing campaign components may be generated at marketing campaign system or framework. A user may then create a marketing campaign using the generated, predefined customizable marketing campaign components. For instance, a user may select various components to create a customized marketing campaign, such as by dragging and dropping the desired components onto a template. The desired components may then be customized, such as for text, font style, font color, background color, and the like. In some examples, various roles may be defined within the system to permit certain users or roles to have access to more features within the system than other users or roles. For instance, an administrator role may be permitted access to the system to create or generate additional components or modules, as well as creating a campaign or promotion by selecting existing components or modules.

In some examples, the customizable marketing campaign system and/or framework may use a widget framework, as described in Appendix A, to assist in generating marketing campaign components. For instance, Appendix A describes, in some arrangements, a method for outputting a widget in response to receiving a widget identifier, which may be used in conjunction with at least some aspects of this disclosure. In some examples, the widget may be configured to communicate with a secure database of an entity implementing the widget, such as, in some examples, a financial institution. The method may include the steps of: determining that the widget identifier is in the mapping table, retrieving appropriate data from the properties file and secure database; and generating/transmitting presentation code corresponding to the desired widget.

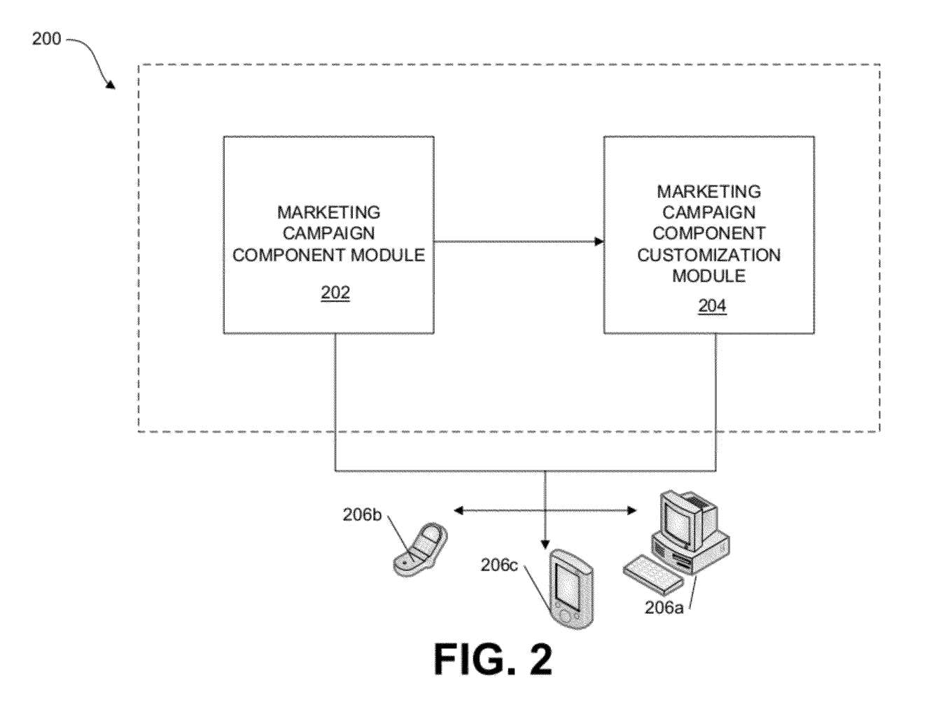

FIG. 2 illustrates one example modular marketing campaign system or framework 200. Marketing campaign system 200 may be part of or contained within an entity, such as a corporation, business, or other entity, implementing the system 200. Alternatively, the system 200 may be external to the entity implementing the system. The system 200 may include a marketing campaign component module 202 that may store or access a library of marketing campaign components. In some examples, additional marketing campaign components may be generated and added to the library, as desired. The system 200 may further include a marketing campaign component customization module 204. The marketing campaign component customization module 204 may include customization parameters for each marketing campaign component, such as the components stored in marketing campaign component module 202, that may be accessed and/or customized by a user.

The system 200 may be accessed by a user, such as via a user computer terminal 206a (e.g., laptop computer, desktop computer, notebook computer, etc.), a cell phone or smart phone 206b and/or a personal digital assistance (PDA) 206c. Communication between the user computing devices 206a-206c and the marketing campaign system 200 may be done via a network, such as the Internet, and/or via an internal communication system such as an intranet of the entity implementing the system. For instance, a user may access the marketing campaign system or framework via a company intranet accessed on their work terminal (such as personal computer 206a). The user may create the marketing campaign via the marketing campaign system from the work terminal and generate the marketing campaign which will then be provided as a marketing tool to customers, potential customers, etc., for instance, via the Internet, intranet, etc.

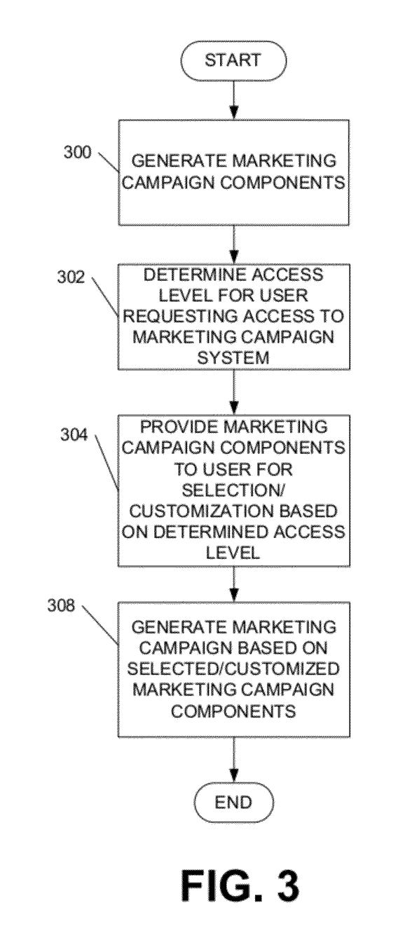

FIG. 3 illustrates one example method of providing the customizable marketing campaign modules to a user for selection. In step 300, a plurality of marketing campaign components may be generated. For instance, a plurality of text blocks, layouts, graphics, icons, links or maps, etc. may be generated and stored, for instance, in the marketing campaign component module 202. In some examples, the marketing campaign components may be predefined graphics, text blocks, etc. that may allow a user to customize the particular text of a text block, identify a desired font style for the text, etc., as will be discussed more fully below. In step 302, an access level for a predefine user or role may be determined. For instance, one or more roles may be assigned to a user attempting to access the modular marketing campaign system. Each of the one or more roles may have different access levels. For instance, two levels may be defined: administrator and customer. In some examples, an administrator may have access to the system to create a marketing campaign, and may also have access permitting the user to create additional marketing campaign components. Alternatively, a user having customer access may have access to create a marketing campaign, however, the user might not have access to develop or generate additional marketing campaign components. In another example, three user roles or access levels may be identified. For instance, a first access level or role may provide administrator access, while a second access level or role may provide a first level of customer access in which all components may be customized using all available customization parameters (e.g., color, font style, font color, graphics, etc.). A third access level or role may permit a user to create a marketing campaign using the system, however, some marketing module components may have limited customization or access to limited customization parameters. For instance, if Company A generally uses the colors blue, gray, white and red as its standard company colors for marketing and advertising, a user having the third access level might be able to customize the color customization parameter within these preset bounds (e.g., may use only blue, gray, white, and red, and/or various shades thereof) when customizing components. However, a user having the second access level may be able to determine or identify new colors that will be used for Company A and thus may be able to customize using the entire color palette. The above-described access levels are merely example levels of access. More or fewer access levels may be used without departing from various aspects of the invention.

In step 304, the marketing campaign components are provided to a user for selection and/or customization. In some examples, the components available for use may be limited due to the access role of the user. Additionally or alternatively, the customization parameters available to the user for the components may be limited based on the access level of the user. In step 306, the selected marketing campaign components are received at the system and the marketing campaign is generated in step 308, based on the selected marketing campaign components and customization thereof

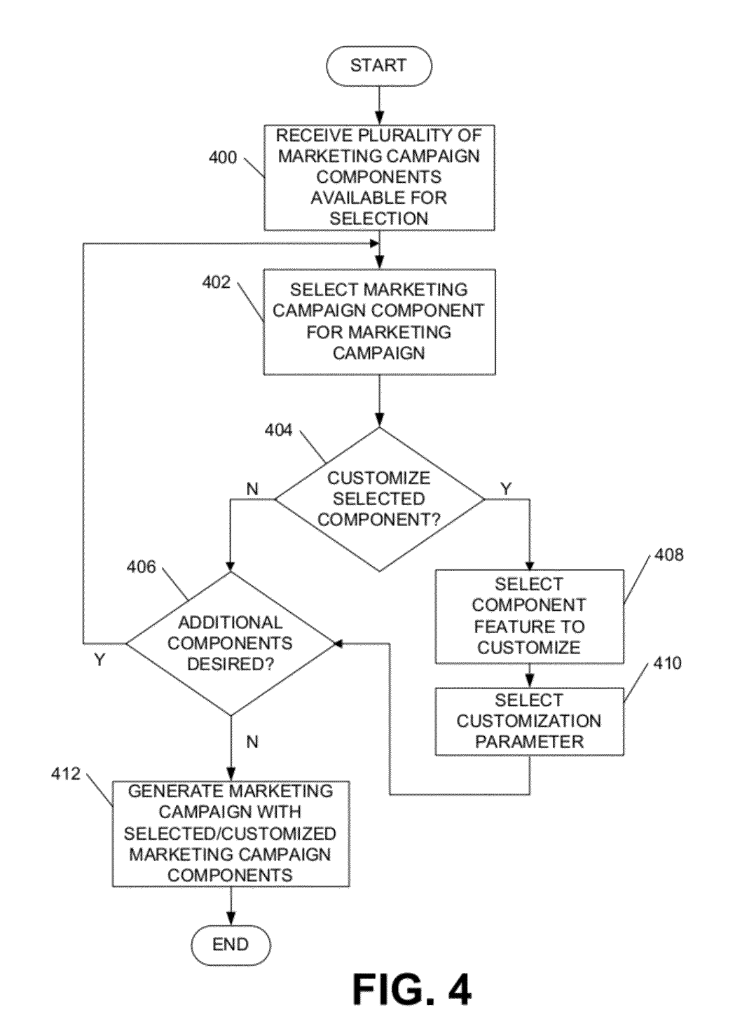

FIG. 4 illustrates another example of creating a marketing campaign using a modular marketing campaign system as described herein. In step 400, a plurality of marketing campaign components are received by a user for selection. Marketing campaign components may include text blocks, graphics, links or maps to websites, and the like. In step 402, a marketing campaign component is selected. In some examples, selection of a marketing campaign component may include selection of a component from a library or listing of available, predefined components. For instance, available marketing campaign components may be stored in a library and may, in some arrangements, be sorted by category. That is, available text blocks that may be selected may be provided and may include options for various sizes, shapes, configurations, etc. of the text block, type of text block (e.g., header or banner, body-type paragraph, bulleted list, etc.). Additionally or alternatively, various graphics may be provided for selection and may be sorted by theme (e.g., banking, commerce, manufacturing, etc.), activity (e.g., sports, relaxation, etc.), and the like. In some arrangements, the marketing campaign components may be selected from the library by clicking on the desired component, dragging it to a template and dropping the component onto the template. In some examples, the component may be dragged to the desired position on the template and dropped in that position. Additionally or alternatively, the template may include default positions for various components and “dropping” the component onto the template may result in the component being positioned in the default location. In some examples, the template may be essentially a blank slate that may be filled with desired marketing campaign components. Additionally or alternatively, the template may be a predefined template having a color scheme and/or layout. A user may select a template or, in some examples, a default template may be provided to receive the desired marketing campaign components.

In step 404, an option is provided to customize the selected marketing campaign component. For instance, once a component is selected, the user may insert desired text or may modify/customize the component by adjusting one or more customization parameters. If customization is desired in step 404, the user may select one or more features of the marketing campaign component to customize in step 408. In step 410, the customization parameter may be selected and the component may be customized. In some examples, customization parameters may include font style, font color, graphics color, and the like. In step 406, a user may determine whether additional marketing campaign components are desired. If additional components are desired, the process may return to step 402 for selection of a marketing campaign component. If no additional components are desired in step 406, the marketing campaign may be generated in step 412.

Alternatively, if no customization is desired in step 404, a determination may be made as to whether an additional marketing campaign component is desired in step 406. Similar to the arrangement above, if additional components are desired, the process may return to step 402 for selection of additional marketing campaign components, or, alternatively, if no additional components are desired, the marketing campaign may be generated in step 412.

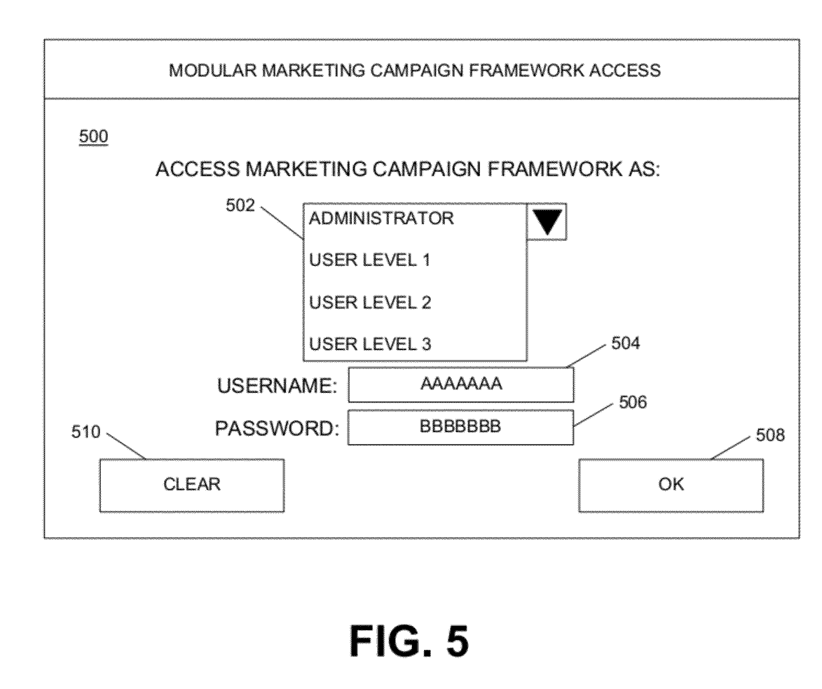

FIG. 5 illustrates one example user interface 500 for accessing the modular marketing campaign system or framework. In field 502, a user may select an access level at which to log into the system. In some examples, the access level may be selected from a drop-down menu, as shown in FIG. 5. A user may then input a username in field 504 and a password in field 506. Upon selecting “ok” option 508, the system may determine whether the username and password are valid and may also determine whether the user associated with the username and password is permitted the desired access level input in field 502. For instance, a look-up table may include a list of users, usernames, etc., as well as an access level for each user, username, etc. If the user attempting to login has the desired access level, access to the system may be permitted. Alternatively, if the user does not have the requested access level, a notification may be sent to the user that access is denied. In some examples, each user may have a predefined role. For instance, user 1 may have an administrator role, while users 2-10 have customer roles. Accordingly, the look-up table may include access levels for each defined role. Thus, upon a user attempting to login to the system, the role of the user may be identified, such as via a look-up table, and available access may be determined in that manner.

Interface 500 may further include a “clear” option 510. Selection of “clear” option 510 may clear all entries or information input to the interface 500.

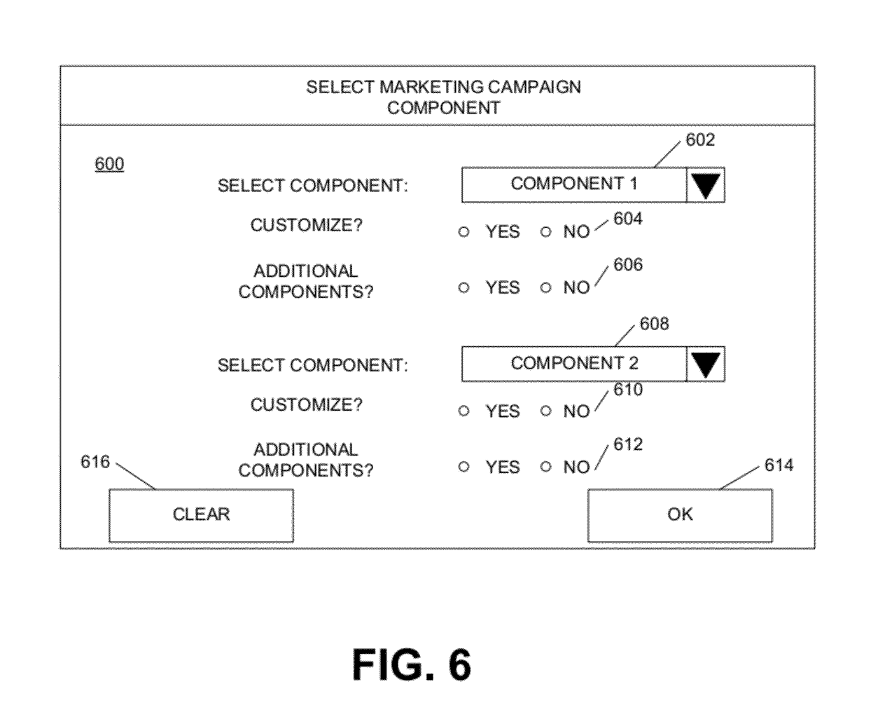

FIG. 6 illustrates one example user interface 600 for selecting marketing campaign components for use with a marketing campaign or promotion. In field 602, a user may select a component to include in the campaign. Marketing campaign components may include text blocks, graphics, layout templates, links or maps to websites, and the like. In some examples, the components may be added to a template that, in some examples, may have a visual or other desired theme. As discussed above, the components may be selected from a list of available components and, in some examples, may be dragged and dropped onto a template for selection.

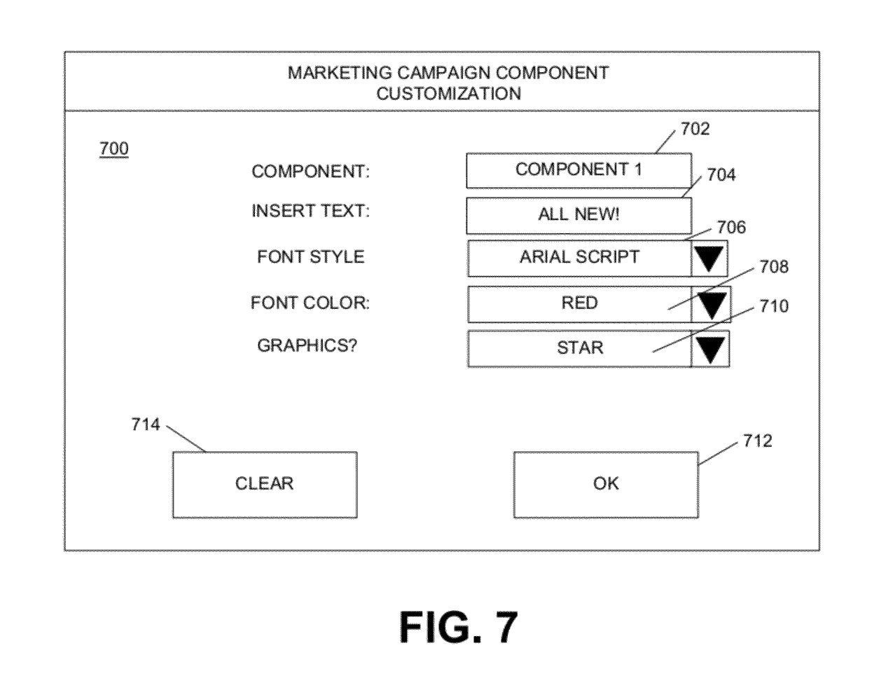

Once a marketing campaign component is selected, the user may customize the selected component by selecting a radio button associated with the “yes” option in field 604. Selection of the “yes” option may prompt a customization user interface to appear, such as user interface 700 in FIG. 7. In field 702, the component being customized is identified. In fields 704-710, various customization parameters may be selected and customized as desired. For instance, customization parameters may include text to include, font style, font color, graphics, etc. The customization parameters may be selected from a list or drop-down menu, or may be presented as thumbnail images, for instance, of available graphics. Once the desired parameters are customized, the user may select “ok” option 712 to process the customization and return the user to the component selection interface 600. Alternatively, the user may select “clear” option 714 to clear all entries in fields in interface 700.

With further reference to FIG. 6, after customizing a first component, as desired, the user may be returned to FIG. 6 to determine whether additional marketing campaign components are desired. If additional components are being selected, the user may select “yes” option in field 606. Selection of “yes” option in field 606 may prompt additional component selection field 608 in which a user may select another marketing campaign component. The user may then select to customize the additional component in field 610 which may prompt a customization user interface such as interface 700 in FIG. 7. If additional components are desired, the user may select to add an additional component in field 612. Once the desired components are selected, the user may select “ok” option 614 to process the selections. Alternatively, the user may clear selections by selecting “clear” option 616.

The above-described modular marketing campaign system or framework may provide several advantages over conventional marketing arrangements. For instance, use of the modular marketing campaign system may permit in-house (e.g., within the company, business, entity, etc. implementing the system) development of marketing campaigns which may reduce costs associated with development of campaigns. That is, producing campaigns in-house may reduce costs associated with securing outside marketing firms and the costs associated with having them develop campaigns, etc. Further, providing the modular marketing campaign system may reduce time associated with developing marketing or advertising campaigns or promotions because the templates and marketing campaign components may quickly be assembled to create a marketing campaign without having to create each campaign from scratch.

Another advantage of the modular marketing campaign system may be that in-house creation of marketing campaigns may ensure compliance with company standards, government regulations and guidelines, etc. For instance, creating and developing marketing campaigns in-house ensures or increases the likelihood of compliance with company guidelines, government regulations (e.g., marketing and advertising regulations in industries such as financial services, pharmaceuticals, legal services, etc.). Further, the modular marketing campaign system described above may further enhance controls to ensure compliance by restricting access to users (e.g., by defining roles or access levels for different users). The modular marketing campaign system may also provide for standardization of marketing campaigns by providing templates, marketing campaign components, etc. having a common theme, color scheme, etc. as, in some examples, approved by the company or entity implementing the system.

Example Systems, Environments, and Software that May be Used with the Customizable Marketing Campaign Framework

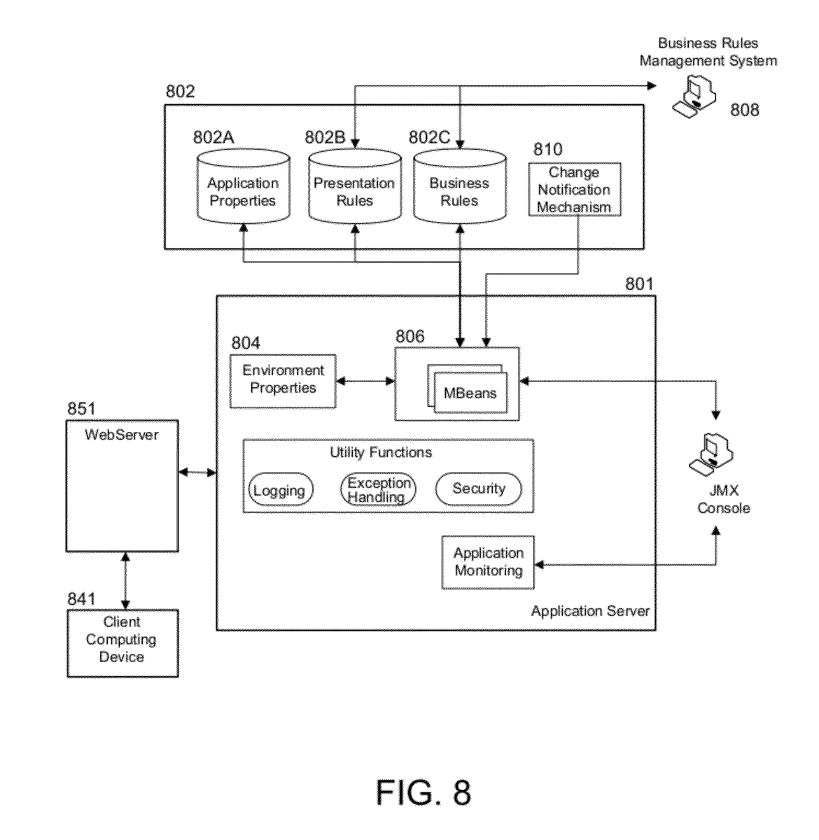

FIG. 8 illustrates one embodiment of a system in accordance with aspects of the disclosure. A client computing device 841 (which may be similar to device 141 in FIG. 1) may communicate with a third-party webserver 851 (which may be similar to device 151 in FIG. 1) that in turn may communicate with an application server 801 (which may be similar to device 101 in FIG. 1) on a different Internet domain. The client computing device 841 may include a display for showing a user the graphical user of the application. As such the application server may include a display interface configured to send a graphical user interface to the display device. The display interface may construct the graphical user interface corresponding to the application by using the business rules (or the modified business rules).

The application server 801 may access data (e.g., application properties, presentation rules, business rules, etc.) stored on a data storage system 802 (e.g., a secure database system). One skilled in the art will appreciate that although various components in FIG. 8 are visually depicted as being located in a particular device, the disclosure contemplates one or more components being located in a different device, a single device, or being omitted. For example, in one embodiment, the data storage system 802 may be located inside the application server 801, or one or more components from data storage system 802 and application server 801 may be located (or co-located) in other blocks of FIG. 8.

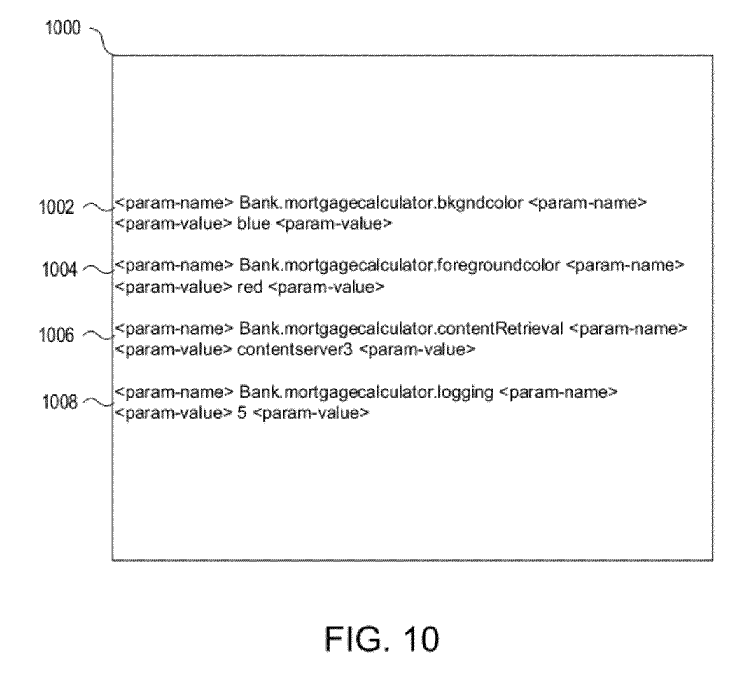

The system of FIG. 8 may include a data storage system 802 configured to hold data for use by one or more applications executing in an application server 801. The data storage system 802 may store data including at least one or more of the following: application properties 802A (e.g., mapping table), presentation rules 802B (e.g., properties files), and/or business rules 802C (e.g., business logic). The terms business rules and business logic may be used interchangeably in this disclosure. Likewise, the terms presentation rules and properties files may be used interchangeably in this disclosure. Examples of illustrative data stored in the data storage system 802 are depicted in FIG. 10, which is described in further detail below. The data storage system 802 may include computer memory (e.g., tangible computer-readable medium) for storing the one or more business rules (e.g., first business rule, second business rule, etc.) Moreover, the data storage system 802 may store a mapping table, properties files (e.g., presentation rules 802B), business logic (e.g., business rules 802C), and other data such as computer-executable instructions. In addition, a business rules management system 808 (BRMS) may be provided to assist in creating, modifying and/or maintaining the various data stored in the data storage system 802. The BRMS may provide a user-friendly graphical user interface (GUI) to allow business users with little to no computer programming (and webpage authoring) experience to create, modify, and maintain the presentation and configuration of an online application (e.g., a website) running with the assistance of a virtual machine.

The data store 802 (e.g., secure database system) may further include a change notification mechanism 810. The change notification mechanism may provide notifications of modification of data (e.g., application properties 802A, presentation rules 802B, business rules 802C, etc.) The notification may take the form of, for example in one embodiment, an alert over an IRQ (interrupt request) line. In another embodiment, the notification may be software-implemented using the well-documented “observer” design pattern where a “subject” and an “observer” are loosely coupled, and the subject provides notification to an observer when the subject changes state. One skilled in the art will appreciate that other configurations or design patterns are known in the art and may be used to provide notifications of modifications (e.g., state changes) of data, such as polling techniques, push techniques, and subject-observer implementations. In addition, the application server 801 may contain an interface to the change notification mechanism 810 so as to enable the receipt of notifications. For example, the application server 801 may include an instantiation of an “observer” configured to obtain notifications of business rule modifications from a “subject” in the data storage system 802.

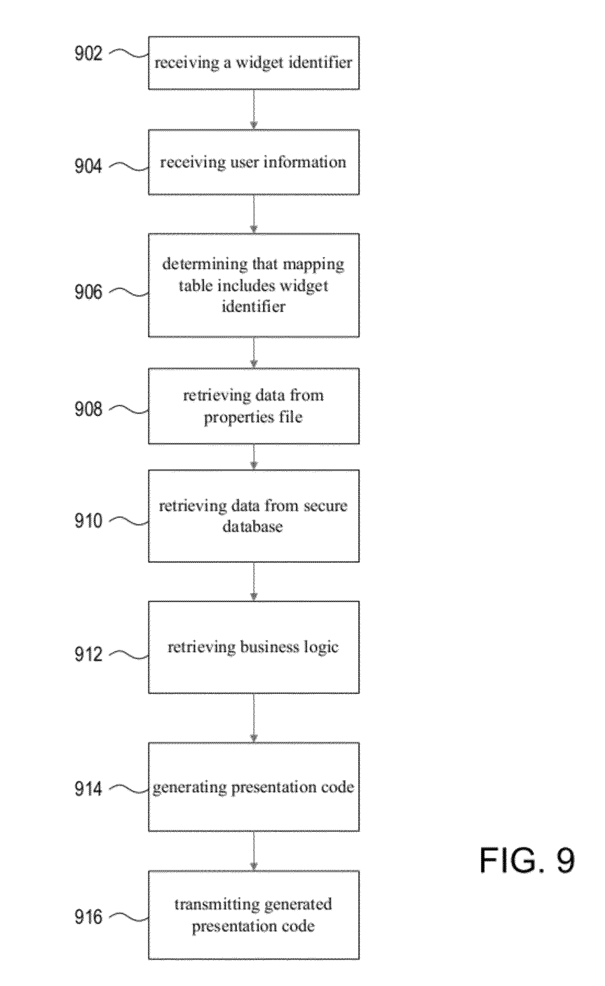

In accordance with various aspects of the disclosure, an application server 801 might not rely on a virtual machine to execute computer-executable instructions. In other embodiments, the application server 801 may include a virtual machine 206 (e.g., a Java™ virtual machine or provide a JRE™) configured to use a processor (e.g., Intel® microprocessor, AMD® microprocessor, multi-core processor, special-purpose processor, etc.) to execute computer-executable instructions. These instructions may include bytecode configured to be executed by the virtual machine to cause the system of FIG. 8 to perform one or more steps identified in FIG. 9 (and throughout this disclosure). The virtual machine 806 may include managed beans (mBeans™) to assist in managing resources (e.g., environment properties file(s) 804, application properties, etc.) and/or performing one or more of the aforementioned steps. mBeans™ are well-known in the art and may be used in conjunction with JMX (e.g., a JMX console) to assist in monitoring aspects of the one or more applications running on the virtual machine 806.

In accordance with various aspects of the disclosure, the virtual machine 806 may also include a rules control mechanism configured to permit an application running on the virtual machine to access a first set of business rules, while concurrently restricting the application from accessing a second set of business rules. Meanwhile, the rules control mechanism may permit a second application also running on the virtual machine 806 to access the second set of business rules, but restrict that application's access to the first set of business rules. One of skill in the art will recognize that at least one benefit of a system with a virtual machine 806 with the rules control mechanism is the ability to restrict visibility of properties (e.g., business rules, presentation rules, environment properties 804, etc.) at the level of the application. For example, different applications may then have the same names for properties without conflict. Therefore, interchangeability of underlying vendor products and future porting are greatly enhanced and simplified. In one embodiment in accordance with the disclosure, the rules control mechanism may be implemented using mBeans™ (see Ref. 806 in FIG. 8). In another embodiment in accordance with the disclosure, the rules control mechanism may be implemented through computer-executable instructions stored on a tangible computer-readable medium of the application server 801 and executed by the virtual machine 806.

In addition, the system of FIG. 8 may include utility functionality to assist in the dynamic configuration of properties. For example, a logging module may be included to record the login of the user that edits a property value in a properties file and the date/time when the modification occurred (e.g., by populating “modified_by” and “modified_date” fields in a log table). The logged information may provide, inter alia, an audit trail for modifications to business rules, presentation rules, application properties, environment properties, etc. In another embodiment, the logging module may provide the ability to designate the level of detail to record in application logs. For example, a logging level of “5” may indicate that all error messages and warning messages generated by the application should be recorded in a log file. (See FIG. 10, ref 1008). In addition, modules for other utility functions (e.g., exception handling module and security module in FIG. 8) may be provided to assist application developers and testers in handling exceptions and security. For example, a security module may provide information about what application developers and/or business users may modify which properties. At least one benefit of a security module is that it may prevent lay business users from accessing and mistakenly modifying a property value that could cause the entire system to crash (e.g., generate a fatal error message or other undesirable behavior.)

FIG. 9 is a flowchart illustrating one embodiment of a method in accordance with aspects of the disclosure. One or more aspects of the method may be implemented using a system (e.g., the system illustrated in FIG. 8.) In step 902, an electronic apparatus (e.g., application server 801) may receive a widget identifier from a remotely located device (e.g., user computing device 841 executing javascript code transmitted from a third-party webserver 851). A widget identifier may be a string value (e.g., “mortgageCalculator”) descriptive of the functionality of a widget. In one example, a widget may comprise a mortgage calculator. The widget may comprise javascript code configured to be executed on a client's web browser on a remotely located electronic device (e.g., user computing device 841). Alternatively, the widget may comprise programming code of a different type that can execute on the user computing device 841.

In optional step 904, the electronic apparatus may receive user information. The user information may be transmitted to the electronic apparatus from a webpage remotely located on the user computing device 841. The webpage may have been downloaded from a third-party webserver (e.g., server 851). The user information may provide information such as the user's name, login, preferences, status, etc. For example, a webpage may include, inter alia, a widget identifier for a mortgage calculator from a particular financial institution. The webpage may also securely include information about the webpage user, such as the user's login with the financial institution. Such user information may be used to further customize the widget presented to the user on the webpage. One skilled in the art, after review of the entirety disclosed herein, will appreciate that not every embodiment of the disclosure will include optional step 904 because, among other things, a user and/or financial institution may not wish to put a customer's user information at risk. Nevertheless, in such cases where security is not an overriding concern, information about a user may be shared with the electronic apparatus in generating a widget for the webpage (or web application).

In step 906, the electronic apparatus 801 may determine whether the mapping table (e.g., stored in data storage 802) includes the widget identifier. The widget mapping table may serve as a mapping between a widget identifier and the resources associated with the widget. For example, a mortgage calculator widget may be identified with a widget identifier of “mcalc”, however, the properties files, business logic, and/or other data stored on the electronic apparatus may not be named using an obscure widget identifier. Rather, the widget mapping table may be used to associate the appropriate resources with the possibly arbitrary widget identifier. In some instances the mapping table may be implemented in a database table (e.g., SQL table with an entry for each widget identifier). Alternatively, the mapping table may be implemented as an electronic file. In step 906, the appropriate resources are identified once the widget identifier is found in the mapping table. If the identifier is not found, an error message may be displayed to the user or thrown, but suppressed. In addition, one of skill in the art, after review of the entirety disclosed herein and incorporated herein by reference, will appreciate that the entries in the mapping table may be dynamically updated using one or more of the features of system in FIG. 8, including but not limited to the change notification mechanism 810.

In step 908, the electronic apparatus 801 may retrieve data from a properties file associated with the widget identifier. The data retrieved from the properties file may include, but is not limited to, background color, foreground color, logging level, and content retrieval server identification. Background color and foreground color are examples of information about the graphical composition of the widget. FIG. 10 illustrates one example of a properties file stored at data store 802 in accordance with various aspects of the disclosure. FIG. 10 is discussed in greater detail below. One skilled in the art after review of the entirety disclosed herein, including that which is incorporated by reference, will appreciate that FTL files may also serve as properties files.

In optional step 910, the electronic apparatus 801 may retrieve data from a secure database (such as database 121 in FIG. 1). As explained in connection with step 904, in some embodiments, it may be undesirable to access user data in a secure database (e.g., a system of record) when, for example, security is a critical issue. In embodiments where retrieving user data from the secure database is permissible, user information received in step 904 may be used to obtain a more comprehensive assessment of the user. For example, the user's basic user information may be used to obtain greater information stored about the user in the secure database. In some embodiments, the user information may be as generic as the type of web browser the user is using.

In step 912, the electronic apparatus 801 may retrieve business logic corresponding to the widget identifier. The widget's business logic may be stored in data storage 802. The business logic of a widget may include programming code (e.g., javascript) that controls how the widget functions and operates. For example, a mortgage calculator widget may access memory to determine the current loan interest rate and perform mathematical calculations on that interest rate. The business logic underlying the calculations may enable a user to enter information and receive results.

In step 914, the electronic apparatus 801 may generate presentation code (e.g., text formatted in HTML, javascript, etc.) corresponding to the widget by, inter alia, executing the business logic corresponding to the widget identifier. In some examples, the retrieved data from step 908 and retrieved data from step 910 may also be used in generating the presentation code. For example, the business logic may read the background color value from a properties file to determine what color to render the background of the widget. Likewise, a contentRetrieval value may be read from a properties file, in one example, to determine what text to display for the widget. In Japan the text may be displayed in kanji script, while in Germany the text may be displayed in the German language. In another example, user information, such as the user's first name, may be incorporated into the widget display to customize the greeting for a user.

Finally in step 916, the presentation code generated in step 914 may be transmitted to the user computing device 841 remotely located from the application server 801. A communications module (e.g., interface 109 in FIG. 1) may assist in sending the generated presentation code to remote electronic device 841. When the presentation code is received at computing system 841, the presentation code (e.g., HTML snippet) may be dynamically inserted into a webpage (or web application) at a predetermined marker. In the case of HTML webpages, the predetermined marker may be a “<div>” tag with the widget identifier as the value of the tag name. Using the document object model of the HTML webpage, the computing system 141 may insert on-the-fly the widget's presentation code at the position of the predetermined marker. Although the display widget is from the application server 801, the webpage may be from a computer server 851 on a completely different Internet domain. As such, the application server 801 may universally provide its widget to others on the Internet to embed (or configure to behave as a “pop-up”) in their existing webpages.

Referring to FIG. 10, an illustrative properties file 1000 in accordance with aspects of the disclosure is shown. The contents of the properties file may adhere to a dot-delimited naming convention to permit the rules to be grouped. For example, property values related to a mortgage calculator widget belonging to “Bank” may include rules 1002, 1004, 1006, 1008. At least one benefit of such a naming convention is that, in some example, the rules control mechanism in a virtual machine 806 may efficiently permit or restrict an application's access to properties/parameters accordingly.

Furthermore, the values in the illustrative properties file 1000 of FIG. 10 may assist in generating the widget's presentation code. For example, property-value pair 1006 may direct the widget in content retrieval. In particular, value 406 may direct the application server 801 to retrieve the content for its widget display from the “contentserver2” content server. In another example, the property-value pair 1008 may include a value indicating log level. A level “5” logging setting may mean that every warning and error gets displayed. Meanwhile, the values for background color (see 1002) and foreground color (see 1004) may be used in generating the presentation code that will determine the look and feel of the widget displayed on the user's computer screen. One skilled in the art will appreciate that properties file may be stored in a file format 1000 or other format (e.g., in a SQL table in a relational database, etc.) on the data storage system 802.

Although not required, one of ordinary skill in the art will appreciate that various aspects described herein may be embodied as a method, a data processing system, or as a computer-readable medium storing computer-executable instructions. Aspects of the invention have been described in terms of illustrative embodiments thereof. Numerous other embodiments, modifications and variations within the scope and spirit of the appended claims will occur to persons of ordinary skill in the art from a review of this disclosure. For example, the disclosure contemplates an application server 801 that executes compiled computer-readable instructions and does not rely on a virtual machine 802 as depicted in FIG. 8. In other words, various embodiments of the claimed invention may operate without necessitating a virtual machine 806. In another example, one of ordinary skill in the art will appreciate that the steps illustrated in the illustrative figures may be performed in other than the recited order, and that one or more steps illustrated may be optional in accordance with aspects of the disclosure. In addition, the steps described herein may be performed using a processor executing computer-executable instructions stored on a computer-readable medium. The processor may also be in communication with a display screen for outputting the appropriate information in accordance with aspects of the invention.

The methods and features recited herein may further be implemented through any number of non-transitory computer readable media that are able to store computer readable instructions. Examples of non-transitory computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the disclosure is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present disclosure. The description is thus to be regarded as illustrative instead of restrictive on the present disclosure.

What is claimed is:

1. A method, comprising:
generating, by a marketing campaign system, a plurality of marketing campaign components;
providing, by the marketing campaign system, the generated plurality of marketing campaign components for selection;
receiving, by the marketing campaign system, user input selecting at least one marketing campaign component of the plurality of marketing framework components; and
generating, by the marketing campaign system, a marketing campaign including the selected at least one marketing framework component.

2. The method of claim 1, wherein the plurality of marketing campaign components are preconfigured marketing modules having customization parameters.

3. The method of claim 2, wherein the customization parameters are modifiable within predefined modification ranges.

4. The method of claim 2, wherein the customization parameters include at least one of text, color, and font style.

5. The method of claim 1, further including:
receiving, at the marketing campaign system, a first user role;
determining, by the marketing campaign system, that the first user role meets a predetermined user role threshold; and
responsive to determining that the first user role meets the predetermined user role threshold, providing, by the marketing campaign system, access to the generated plurality of marketing campaign components.

6. The method of claim 5, further including responsive to determining that the first user role does not meet the predetermined user role threshold, denying access to the generated plurality of marketing campaign components.

7. The method of claim 1, further including:
receiving, at the marketing campaign system, a first user role;
determining, by the marketing campaign system, that the first user role meets a predetermined user role threshold; and
responsive to determining that the first user role meets the predetermined user role threshold, providing, by the marketing campaign system, access to the generated plurality of marketing campaign components.
responsive to determining that the first user role does not meet the predetermined user role threshold, denying access to the generated plurality of marketing campaign components.

8. A method, comprising:
identifying, by a marketing campaign system, a first marketing campaign component for selection from a plurality of marketing campaign components;
determining, by the marketing campaign system, whether the first marketing campaign component will be customized;
responsive to determining that the first marketing campaign component will be customized, selecting at least one customization parameter for customizing the first marketing campaign component;
determining, by the marketing campaign system, whether additional marketing campaign components are identified; and
responsive to determining that no additional marketing campaign components are identified, generating a marketing campaign based on the identified first marketing campaign components and the selected at least one customization parameter.

9. The method of claim 8, further including, responsive to determining that additional marketing campaign components are identified, the additional marketing campaign components including a second marketing campaign component, determining, by the marketing system, whether the second marketing campaign component will be customized.

10. The method of claim 9, further including responsive to determining that the second marketing campaign component will be customized, selecting at least one customization parameter for customizing the second marketing campaign component.

11. The method of claim 9, further including:
determining, by the marketing campaign system, whether additional marketing campaign components are identified; and
responsive to determining that no additional marketing campaign components are identified, generating a marketing campaign based on the identified first and second marketing campaign components and the selected at least one customization parameter for the first and second marketing campaign components.

12. The method of claim 9, further including:
responsive to determining that the second marketing campaign component will be customized, selecting at least one customization parameter for customizing the second marketing campaign component;
determining, by the marketing campaign system, whether additional marketing campaign components are identified; and
responsive to determining that no additional marketing campaign components are identified, generating a marketing campaign based on the identified first and second marketing campaign components and the selected at least one customization parameter for the first and second marketing campaign components.

13. One or more non-transitory computer readable media storing computer readable instructions that, when executed, cause an apparatus to:
identify, by a marketing campaign system, a first marketing campaign component for selection from a plurality of marketing campaign components;
determine, by the marketing campaign system, whether the first marketing campaign component will be customized;
responsive to determining that the first marketing campaign component will be customized, select at least one customization parameter for customizing the first marketing campaign component;
determine, by the marketing campaign system, whether additional marketing campaign components are identified; and
responsive to determining that no additional marketing campaign components are identified, generate a marketing campaign based on the identified first marketing campaign components and the selected at least one customization parameter.

14. The one or more non-transitory computer readable media of claim 13, further including instructions that, when executed, cause the apparatus to, responsive to determining that additional marketing campaign components are identified, the additional marketing campaign components including a second marketing campaign component, determine, by the marketing system, whether the second marketing campaign component will be customized.

15. The one or more non-transitory computer readable media of claim of claim 14, further including instructions that, when executed, cause the apparatus to, responsive to determining that the second marketing campaign component will be customized, select at least one customization parameter for customizing the second marketing campaign component.

16. The one or more non-transitory computer readable media of claim of claim 14, further including instructions that, when executed, cause the apparatus to:
determine, by the marketing campaign system, whether additional marketing campaign components are identified; and
responsive to determining that no additional marketing campaign components are identified, generate a marketing campaign based on the identified first and second marketing campaign components and the selected at least one customization parameter for the first and second marketing campaign components.

17. The one or more non-transitory computer readable media of claim 9, further including instructions that, when executed, cause the apparatus to:
responsive to determining that the second marketing campaign component will be customized, select at least one customization parameter for customizing the second marketing campaign component;
determine, by the marketing campaign system, whether additional marketing campaign components are identified; and
responsive to determining that no additional marketing campaign components are identified, generate a marketing campaign based on the identified first and second marketing campaign components and the selected at least one customization parameter for the first and second marketing campaign components.

18. An apparatus, comprising:
a processor; and
memory operatively coupled to the processor and storing computer readable instructions that, when executed, cause the apparatus to:
identify, by a marketing campaign system, a first marketing campaign component for selection from a plurality of marketing campaign components;
determine, by the marketing campaign system, whether the first marketing campaign component will be customized;
responsive to determining that the first marketing campaign component will be customized, select at least one customization parameter for customizing the first marketing campaign component;
determine, by the marketing campaign system, whether additional marketing campaign components are identified; and
responsive to determining that no additional marketing campaign components are identified, generate a marketing campaign based on the identified first marketing campaign components and the selected at least one customization parameter.

19. The apparatus of claim 18, further including instructions that, when executed, cause the apparatus to, responsive to determining that additional marketing campaign components are identified, the additional marketing campaign components including a second marketing campaign component, determine, by the marketing system, whether the second marketing campaign component will be customized.

20. The apparatus of claim of claim 19, further including instructions that, when executed, cause the apparatus to, responsive to determining that the second marketing campaign component will be customized, select at least one customization parameter for customizing the second marketing campaign component.

21. The apparatus of claim of claim 19, further including instructions that, when executed, cause the apparatus to:
determine, by the marketing campaign system, whether additional marketing campaign components are identified; and
responsive to determining that no additional marketing campaign components are identified, generate a marketing campaign based on the identified first and second marketing campaign components and the selected at least one customization parameter for the first and second marketing campaign components.

22. The apparatus of claim 19, further including instructions that, when executed, cause the apparatus to:
responsive to determining that the second marketing campaign component will be customized, select at least one customization parameter for customizing the second marketing campaign component;
determine, by the marketing campaign system, whether additional marketing campaign components are identified; and
responsive to determining that no additional marketing campaign components are identified, generate a marketing campaign based on the identified first and second marketing campaign components and the selected at least one customization parameter for the first and second marketing campaign components.
